(19) United States
(12) Patent Application Publication
(10) Pub. No.: US 2026/0254901 A1
(43) Pub. Date: Aug. 27, 2026

(54) INFORMATION PROCESSING METHOD, INFORMATION PROCESSING APPARATUS, AND IMAGE FORMING APPARATUS

(71) Applicant: KYOCERA Document Solutions Inc., Osaka (JP)

(72) Inventors: Masato Hirabe, Osaka (JP); Kohei Konishi, Osaka (JP); Yoshifumi Okabayashi, Osaka (JP); Toshimasa Takaoka, Osaka (JP); Jin Daicho, Osaka (JP)

(21) Appl. No.: 19/548,698

(22) Filed: Feb. 24, 2026

(30) Foreign Application Priority Data
Feb. 26, 2025 (JP) 2025-028770

(51) Int. Cl. H04N 1/00; G06F 3/12

(52) U.S. Cl. CPC H04N 1/00506; G06F 3/1208; G06F 3/1255; H04N 1/00411; H04N 1/0048; G06F 3/1287; H04N 2201/0094

(57) ABSTRACT

An information processing method is a method of controlling display of a display device in a target apparatus (image forming apparatus) including the display device that displays an operation screen and an operation device that detects an operation on the operation screen. In the information processing method, one or more processors execute: transmitting specific data stored in advance by the target apparatus to an external system, and receiving external content generated by the external system on the basis of the specific data; and displaying the received external content on the display device in a state being superimposed on the operation screen.

### INCORPORATION BY REFERENCE

This application is based upon and claims the benefit of priority from the corresponding Japanese Patent Application No. 2025-028770 filed on February 26, 2025, the entire contents of which are incorporated herein by reference.

The present disclosure relates to an information processing method, an information processing apparatus, and an image forming apparatus that cause a display device to display an operation screen.

### BACKGROUND

An information processing apparatus that displays an operation screen provided from a web server is known as a related art.

### SUMMARY

An information processing method according to an aspect of the present disclosure is an information processing method of controlling display of a display device in a target apparatus including the display device that displays an operation screen and an operation device that detects an operation on the operation screen. In the information processing method, one or more processors execute: transmitting specific data stored in advance by the target apparatus to an external system, and receiving external content generated by the external system on the basis of the specific data; and displaying the received external content on the display device in a state being superimposed on the operation screen.

An information processing apparatus according to another aspect of the present disclosure includes: a display device that displays an operation screen; an operation device that detects an operation on the operation screen; and one or more processors that implement the information processing method described above.

An image forming apparatus according to another aspect of the present disclosure includes: a printing device that forms an image on a sheet; a display device that is capable of displaying the image; and an operation device that detects an operation on the operation screen. Further, the image forming apparatus includes one or more processors that cause the display device to display an operation screen of a target apparatus including the printing device, and implement the information processing method described above.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming apparatus according to an embodiment.

FIG. 2 is a diagram showing an example of an operation screen displayed in the image forming apparatus according to the embodiment.

FIG. 3 is a diagram showing an example of an operation screen including external content displayed in the image forming apparatus according to the embodiment.

FIG. 4 is a sequence diagram showing an operation example of the image forming apparatus according to the embodiment.

FIG. 5 is a diagram showing a first display example of the external content in the image forming apparatus according to the embodiment.

FIG. 6 is a diagram showing another example of the first display example of the external content in the image forming apparatus according to the embodiment.

FIG. 7 is a diagram showing a second display example of the external content in the image forming apparatus according to the embodiment.

FIG. 8 is a diagram showing a third display example of the external content in the image forming apparatus according to the embodiment.

FIG. 9 is a diagram showing a fourth display example of the external content in the image forming apparatus according to the embodiment.

FIG. 10 is a diagram showing a fifth display example of the external content in the image forming apparatus according to the embodiment.

### DETAILED DESCRIPTION

Hereinafter, an embodiment of the present disclosure will be described with reference to the drawings. Note that the following embodiment is an example embodying the present disclosure and is not intended to limit the technical scope of the present disclosure.

### Configuration of Image Forming Apparatus 10

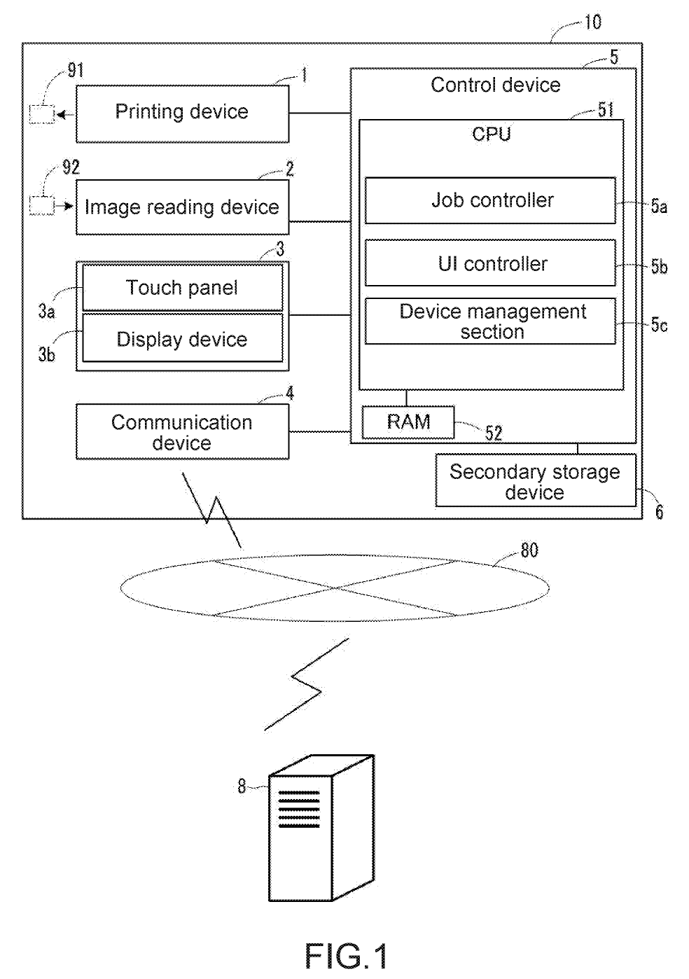

An image forming apparatus 10 according to the embodiment includes, as shown in FIG. 1, a printing device 1 that performs print processing and a user interface device 3. Here, the print processing is processing of forming an image on a sheet 91. The image forming apparatus 10 is, for example, a printer, a copying machine, a facsimile machine, or a multifunction peripheral.

The user interface device 3 includes a touch panel 3a that detects a touch operation, and a display device 3b capable of displaying an image. The touch panel 3a is disposed on a screen of the display device 3b. The touch panel 3a is an example of an operation device that detects an operation. Hereinafter, the touch panel 3a is referred to as "operation device 3a" in some cases. The image forming apparatus 10 is an example of a target apparatus including the operation device and the display device 3b, or an information processing apparatus.

In the example shown in FIG. 1, the image forming apparatus 10 includes the printing device 1, an image reading device 2, the user interface device 3, a communication device 4, a control device 5, and a secondary storage device 6. The image forming apparatus 10 is capable of communicating with an external system 8 via a network 80. The network 80 includes, for example, a local area network (LAN) or the Internet.

The external system 8 is, for example, an information processing apparatus such as a server, a personal computer, a tablet computer, or a smartphone. The external system 8 may have functions that the image forming apparatus 10 serving as a target apparatus does not have, for example. In this embodiment, the external system 8 has a function of generating a graph image, as a function that the image forming apparatus 10 does not have, as will be described later. In addition, the external system 8 may have, for example, the same function as that of the image forming apparatus 10 serving as a target apparatus, and may have a higher processing capacity when using that function than the processing capacity of the image forming apparatus 10 when using that function.

The printing device 1 performs print processing by a predetermined method such as an electrophotographic method or an inkjet method. The printing device 1 includes a sheet conveying mechanism (not shown) that conveys a sheet 91, and an image forming section (not shown) that forms an image on the conveyed sheet 91. The printing device 1 performs print processing based on data of a read image that has been read by the image reading device 2 or based on received print data. Here, the received print data is data contained in a print request that is received from another apparatus, such as the external system 8, via the communication device 4.

The image reading device 2 performs image reading processing. Here, the image reading processing is processing of reading an image from a document 92. The image reading device 2 includes an optical scanning mechanism (not shown) that scans the document 92 with light, and an image sensor (not shown) that receives reflection light that has been reflected on the document 92. The image sensor outputs data of a read image. Here, the read image is an image that has been read from the document 92.

The communication device 4 is a communication interface device that performs communication with another apparatus, such as the external system 8, via the network 80. The control device 5 performs all data transmission and reception with the other apparatus via the communication device 4. The communication of the communication device 4 with the other apparatus may be wired communication or may be wireless communication.

In addition, the communication device 4 is capable of performing image transmitting processing. Here, the image transmitting processing is processing of transmitting the data of the read image that has been read by the image reading device 2 to a destination specified by a user via the network 80. In this embodiment, the image transmitting processing includes network facsimile transmitting processing of transmitting the data of the read image via the network 80.

The control device 5 performs various types of computation, data processing, and control of various electrical devices included in the image forming apparatus 10. In addition, the control device 5 controls display of the display device 3b by controlling the display device 3b.

The control device 5 includes a central processing unit (CPU) 51, a random access memory (RAM) 52, and the like. The CPU 51 is one or more processors that perform various types of data processing and control by executing computer programs. Note that another one or more processors such as a digital signal processor (DSP) may perform the various types of data processing and control, instead of the CPU 51.

The RAM 52 is a computer-readable volatile storage device. The RAM 52 temporarily stores computer programs executed by the CPU 51 and data and the like that are output and referenced in the process of the CPU 51 executing computer programs.

The secondary storage device 6 is a computer-readable nonvolatile storage device. The secondary storage device 6 is capable of storing computer programs, various types of data, and the like. The secondary storage device 6 is, for example, a flash memory such as a solid state drive (SSD), a hard disk drive, or the like.

The control device 5 is capable of performing data recording processing. Here, the data recording processing is processing of recording the data of the read image obtained by the image reading device 2 or the received print data obtained via the communication device 4 in the secondary storage device 6.

The CPU 51 includes a plurality of processing modules that are implemented by executing the computer programs described above. In this embodiment, the CPU 51 includes a plurality of processing modules such as a job controller 5a, a user interface (UI) controller 5b, a device management section 5c, and the like.

The job controller 5a performs job control. Here, the job control is processing of causing each device of the image forming apparatus 10 to perform the image processing that corresponds to a request input via the touch panel 3a or the communication device 4. The job controller 5a controls the printing device 1, the image reading device 2, the communication device 4, and the like. The job controller 5a causes part or all of the printing device 1, the image reading device 2, and the communication device 4 to perform the requested image processing. The image processing used herein includes the print processing performed by the printing device 1, the image reading processing performed by the image reading device 2, the image transmitting processing performed by the communication device 4, the data recording processing performed by the control device 5, and the like.

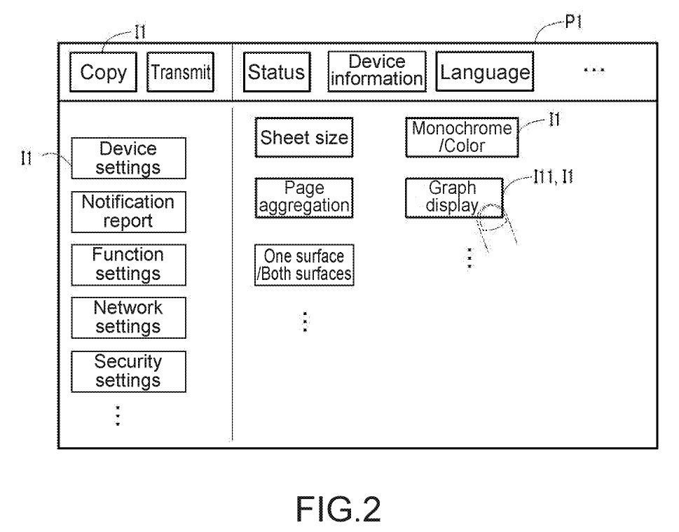

The UI controller 5b is capable of performing display control processing. Here, the display control processing is processing of causing the display device 3b to display various types of information related to the image forming apparatus 10. In this embodiment, the UI controller 5b causes the display device 3b to display an operation screen P1 (see FIG. 2) for inputting various settings of the image forming apparatus 10, instructions for job control to be performed by the image forming apparatus 10, and the like. The operation screen P1 is a user interface that is implemented with a native code. In other words, the operation screen P1 is implemented by a native application installed when the image forming apparatus 10 is manufactured. The UI controller 5b causes the display device 3b to display the operation screen P1 including a plurality of operation icons I1, and causes the display device 3b to display a screen corresponding to an operation to select any one of the plurality of operation icons I1. In this embodiment, the operation to select any one of the plurality of operation icons I1 is detected by the touch panel 3a serving as an operation device. In addition, the plurality of operation icons I1 correspond to operation items that each receive a corresponding specific operation.

FIG. 2 is a diagram showing an example of the operation screen P1 displayed on the display device 3b. As shown in FIG. 2, "copy", which is an operation icon I1 to instruct the printing device 1 to perform print processing, and "transmit", which is an operation icon I1 to instruct the communication device 4 to perform image transmitting processing, are displayed in an upper part of the operation screen P1. In addition, "status", which is an operation icon I1 to give an instruction to display a job to be performed by the image forming apparatus 10, and "device information", which is an operation icon I1 to give an instruction to display a status of the image forming apparatus 10, are displayed in the upper part of the operation screen P1. Further, "language", which is an operation icon I1 to indicate a language of a character string displayed on the operation screen P1, is displayed in the upper part of the operation screen P1.

In a left part of the operation screen P1, "device settings", which is an operation icon I1 to give an instruction about various settings of the image forming apparatus 10, and "notification report", which is an operation icon I1 to give an instruction to display an error or the like generated in the image forming apparatus 10, are displayed. In addition, in a sub-part of the operation screen P1, "function settings", which is an operation icon I1 to give an instruction to set various functions of the image forming apparatus 10, and "network settings", which is an operation icon I1 to give an instruction about various settings of the network 80 to which the image forming apparatus 10 is connected, are displayed. Further, in the left part of the operation screen P1, "security settings", which is an operation icon I1 to give an instruction about various settings related to the security of the image forming apparatus 10, is displayed.

In the right part of the operation screen P1, "sheet size", which is an operation icon I1 to give an instruction about the size of the sheet 91, and "page aggregation", which is an operation icon I1 to give an instruction to perform page aggregation processing of aggregating a document over a plurality of pages to the sheet 91, are displayed. In addition, in the right part of the operation screen P1, "one surface/both surfaces", which is an operation icon I1 to give an instruction to perform printing on one surface or both surfaces of the sheet 91, and "monochrome/color", which is an operation icon I1 to give an instruction to perform monochrome printing or color printing on the sheet 91, are displayed.

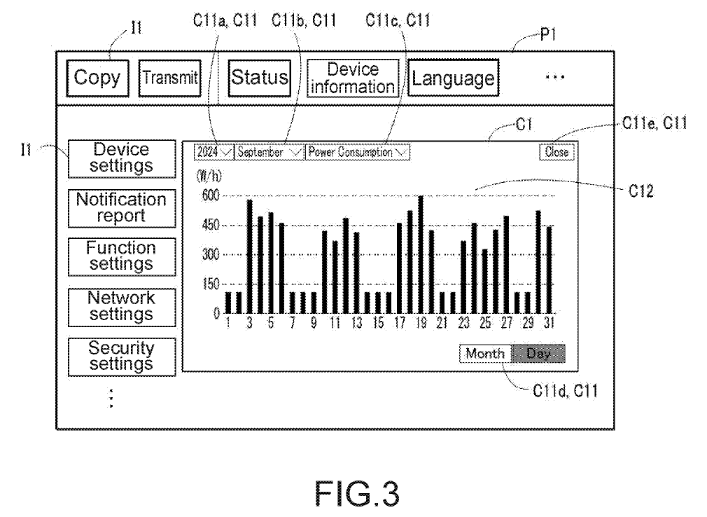

Further, "graph display", which is an operation icon I1 to give an instruction to display a graph serving as external content C1 (see FIG. 3) to be described later, is displayed on the operation screen P1. Hereinafter, the operation icon I1 to give an instruction to display the external content C1 will be also referred to as "operation icon I11". In addition, in this embodiment, it is needless to say that the operation icon I11 is "graph display", but it is changed in accordance with the form of the external content C1 to be displayed.

The device management section 5c determines various statuses of the image forming apparatus 10 and controls an operating state of the image forming apparatus 10 in accordance with the determination result. In addition, the device management section 5c derives and records data indicating an operating situation of the image forming apparatus 10 including the printing device 1, and the like. Here, the data indicating an operating situation includes power consumption data, consumables consumption data, data of the amount of greenhouse gas emission, and the like to be described later.

For example, the device management section 5c determines whether or not a hibernation condition is satisfied, and when the hibernation condition is satisfied, causes the image forming apparatus 10 to shift from a normal mode to a power-saving mode in which less power is consumed than in the normal mode. Here, the hibernation condition includes, for example, that a specific operation is performed on a power supply switch of the image forming apparatus 10 or a continuous time during which no operation has been performed on the image forming apparatus 10 is equal to or larger than a predetermined time.

In addition, the device management section 5c derives hourly, daily, and monthly power consumption of the image forming apparatus 10 on the basis of a detection result of a power detection circuit (not shown) included in the image forming apparatus 10, and records power consumption data indicating the derived results of the power consumption in the secondary storage device 6.

In addition, the device management section 5c derives hourly, daily, and monthly amounts of consumption of consumables on the basis of the detection results of various sensors (not shown) included in the image forming apparatus 10, and records consumables consumption data indicating the derived results of the amount of consumption of consumables in the secondary storage device 6. Here, the amount of consumption of consumables includes, for example, the amount of consumption of a developer consumed in the print processing or the number of sheets 91 used.

In addition, the device management section 5c converts the power consumption and the amount of consumption of consumables, which have been derived, into the amount of greenhouse gas emission and records hourly, daily, and monthly data of the amount of greenhouse gas emission in the secondary storage device 6. The greenhouse gas is, for example, carbon dioxide.

### Information Processing Apparatus (Image Forming Apparatus 10), and Information Processing Method

By the way, in the target apparatus (e.g., image forming apparatus) including the display device that displays an operation screen and the operation device that detects an operation on the operation screen, the operation screen is implemented by a native application installed when the target apparatus is manufactured. Thus, when the operation screen is customized, for example, by adding new functions or new information to the operation screen, the native application is required to be updated, which leads to a problem that the operation screen is difficult to customize.

For example, assumed is the case where the target apparatus is an image forming apparatus and a graph is generated on the basis of data of the image forming apparatus, which indicates an operating situation, and displayed on the operation screen. In this case, if the native application does not have the functions of generating the data indicating the operating situation and displaying the graph on the operation screen, the native application is required to be updated in order to add those functions. In such a manner, if the native application is not updated each time a new function is added, the operation screen cannot be customized. This causes a problem that it is difficult to flexibly customize the operation screen and it is less convenient for the user.

In contrast, in this embodiment, the information processing method, the information processing apparatus, and the image forming apparatus 10 that facilitate customization of the operation screen in the target apparatus can be implemented by the following processing to be executed by the information processing apparatus (image forming apparatus 10).

Specifically, the information processing method according to this embodiment is a method of controlling display of the display device 3b in the target apparatus (image forming apparatus 10) including the display device 3b that displays the operation screen P1 and the operation device 3a that detects an operation on the operation screen P1. The CPU 51 (one or more processors) of the information processing apparatus (image forming apparatus 10) executes a communication step and a processing step.

In other words, the information processing apparatus (image forming apparatus 10) includes the display device 3b that displays the operation screen P1, the operation device 3a that detects an operation on the operation screen P1, and one or more processors (CPU 51) that implement the information processing method. In addition, the image forming apparatus 10 includes the printing device 1 that forms an image on the sheet 91, the display device 3b capable of displaying an image, and the operation device 3a that detects an operation on the operation screen P1. The image forming apparatus 10 also includes one or more processors (CPU 51) that cause the display device 3b to display the operation screen P1 of the target apparatus (image forming apparatus 10) including the printing device 1, and that implement the information processing method.

The communication step is processing of transmitting specific data stored in advance in the target apparatus (image forming apparatus 10) to the external system 8, and receiving external content C1 generated in the external system 8 on the basis of the specific data. Specifically, the CPU 51 controls the communication device 4 to transmit specific data to the external system 8 via the network 80 and receive external content C1 from the external system 8 via the network 80.

Here, the specific data is, for example, data indicating the operating situation of the image forming apparatus 10, such as power consumption data, consumables consumption data, or data of the amount of greenhouse gas emission, which are stored in the secondary storage device 6 of the image forming apparatus 10. Note that the specific data is not limited to the data indicating the operating situation of the image forming apparatus 10, but it only needs to be data held by the image forming apparatus 10.

When receiving the specific data transmitted from the target apparatus (image forming apparatus 10), the external system 8 generates external content C1 on the basis of the received specific data. Here, the external content C1 is not content generated by the native application implemented by the image forming apparatus 10, but content generated by the external system 8. The external content C1 is, for example, general-purpose web content that is generated using a programming language such as HTML (HyperText Markup Language), CSS (Cascading Style Sheets), or JavaScript. In this embodiment, the external content C1 is, by way of example, an image including a bar graph generated on the basis of power consumption data of the image forming apparatus 10. Note that the external content C1 may be in any form that can be displayed on the display device 3b, and is not limited to an image including a bar graph.

Here, in this embodiment, the image forming apparatus 10 serving as the target apparatus does not have the specific functions of generating an image including a bar graph on the basis of power consumption data and displaying the image on the display device 3b. In this regard, the information processing apparatus transmits the specific data (power consumption data) held by the target apparatus to the external system 8. The information processing apparatus then causes the external system 8, instead of the image forming apparatus 10, to generate external content C1 (image including a bar graph on the basis of power consumption data), using the specific functions of the external system 8. In other words, the external content C1 is generated by the external system 8 by using functions that the target apparatus (image forming apparatus 10) does not have. This has the advantage that content using functions that the target apparatus does not have can be displayed on the display device 3b without updating the native application of the target apparatus.

The processing step is processing of displaying the received external content C1 on the display device 3b in a state being superimposed on the operation screen P1. Specifically, the CPU 51 (particularly, the UI controller 5b) displays the operation screen P1 on the display device 3b by the native application provided in advance in the target apparatus (image forming apparatus 10). When receiving the external content C1 from the external system 8 via the network 80, the CPU 51 displays the received external content C1 on the display device 3b in a state being superimposed on the operation screen P1, that is, being embedded into the operation screen P1. In this embodiment, the CPU 51 displays the external content C1 on the operation screen P1 by using the function of a web browser to display web content. In other words, the CPU 51 displays, on the display device 3b, both the operation screen P1 generated by the native application and the external content C1 displayed by the web browser.

FIG. 3 is a diagram showing an example of the operation screen P1 including the external content C1. The operation screen P1 shown in FIG. 3 is displayed after a user operates the operation icon I11 of "graph display" on the operation screen P1 shown in FIG. 2. In the example shown in FIG. 3, the external content C1 includes a plurality of operation icons C11 (a first operation icon C11a to a fifth operation icon C11e to be described later) and a graph image C12 showing a bar graph generated on the basis of the power consumption data. In the example shown in FIG. 3, the graph image C12 represents a bar graph showing daily power consumption of the image forming apparatus 10 in September 2024.

In the example shown in FIG. 3, a first operation icon C11a indicating the year to be displayed, and a second operation icon C11b indicating the month to be displayed are displayed in the upper part of the external content C1. In addition, a third operation icon C11c indicating a type of data showing the operating situation to be displayed is further displayed in the upper part of the external content C1. A fourth operation icon C11d indicating one of a graph image C12 indicating daily power consumption and a graph image C12 indicating monthly power consumption is displayed in the lower right part of the external content C1. A fifth operation icon C11e to give an instruction to stop displaying the external content C1 is displayed in the upper right part of the external content C1. Those operation icons C11 correspond to content operation items for receiving the operations for the external content C1. The operations on the content operation items will be described in <Second Display Example> to be descried later.

In the example shown in FIG. 3, the external content C1 is displayed on the right side of the column including the operation icons I1 such as "device settings" in the operation screen P1. During display of the external content C1, the plurality of operation icons I1 such as "sheet size", which are located at the positions overlapping with the display region of the external content C1, are hidden. Note that the external content C1 may be displayed on the operation screen P1 while being superimposed on the plurality of operation icons I1 such as "sheet size" without hiding the plurality of operation icons I1.

### Operation Example of Information Processing Apparatus (Image Forming Apparatus 10)

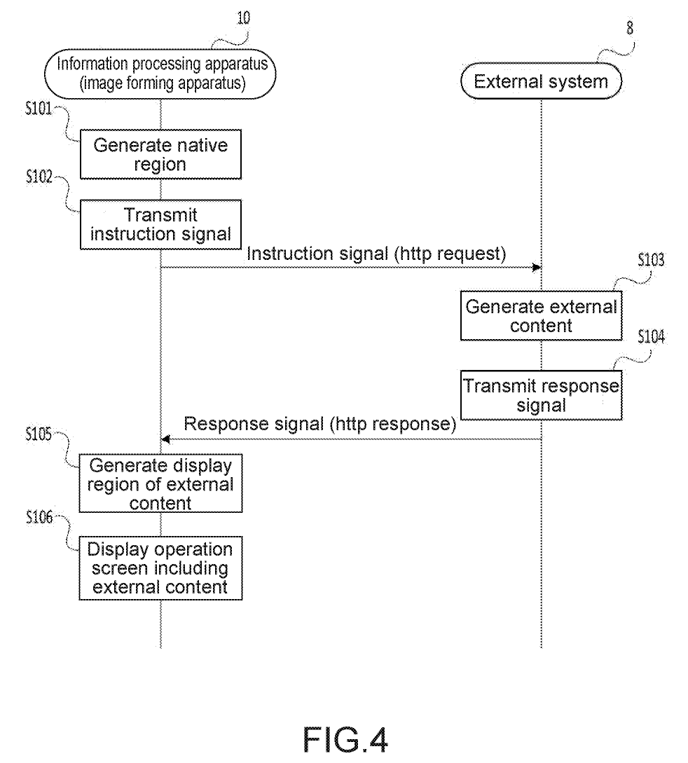

Hereinafter, an example of the information processing method according to this embodiment will be described together with an example procedure of the processing executed by the information processing apparatus (image forming apparatus 10) with reference to FIG. 4. Here, Steps S101, S102, … each represent the number of a processing procedure (step) executed by the information processing apparatus or the external system 8. The processing is started, for example, when a user operates the operation icon I11 (here, the operation icon of "graph display") on the operation screen P1 to give an instruction to display the external content C1.

### Step S101

First, the CPU 51 executes a native application to generate a native region. Here, the native region refers to a display region including the plurality of operation icons I1 and the like displayed on the display device 3b by the native application, and also a display region other than the display region of external content C1 on the operation screen P1. The generation of the native region is achieved by, for example, parsing XML content stored in the secondary storage device 6.

### Step S102

Next, the CPU 51 reads specific data from the secondary storage device 6. The CPU 51 then controls the communication device 4 to transmit, to the external system 8 via the network 80, an instruction signal containing the read specific data and an instruction for the external system 8 to generate external content C1. The instruction signal is achieved by, for example, an http (Hyper Text Transfer Protocols) request.

### Step S103

When receiving the instruction signal from the information processing apparatus (image forming apparatus 10) via the network 80, the external system 8 generates external content C1 on the basis of the specific data contained in the instruction signal.

### Step S104

Next, the external system 8 transmits a response signal containing the generated external content C1 to the information processing apparatus (image forming apparatus 10) via the network 80. The response signal is achieved by a http response, for example.

### Step S105

The CPU 51 controls the communication device 4 to receive the response signal transmitted from the external system 8 via the network 80, and then generates a display region of the external content C1 contained in the response signal. The generation of the display region of the external content C1 is achieved by, for example, parsing the external content C1 by using the native application.

### Step S106

The CPU 51 then displays the generated native region and the generated display region of the external content C1 on the display device 3b. Thus, the operation screen P1 including the external content C1 is displayed on the display device 3b.

Hereinafter, Steps S101 to S106 described above are executed, for example, each time the user performs an operation to give an instruction to change the external content C1. Thus, the external content C1 displayed on the operation screen P1 is updated in real time in accordance with the operation of the user.

As described above, in the information processing apparatus (image forming apparatus 10) according to this embodiment, it is possible to display, on the display device 3b, the external content C1 generated by the external system 8 on the basis of the specific data held by the target apparatus (image forming apparatus 10). Hence, in the information processing apparatus according to this embodiment, it is possible to add a new function or new information, which is difficult for the native application to implement, as external content C1, to the operation screen P1. Therefore, in the information processing apparatus according to this embodiment, it is possible to customize the operation screen P1 using the external content C1 without updating the native application, which is the advantage that the operation screen P1 is easily customized in the target apparatus.

### Display Examples of External Content C1

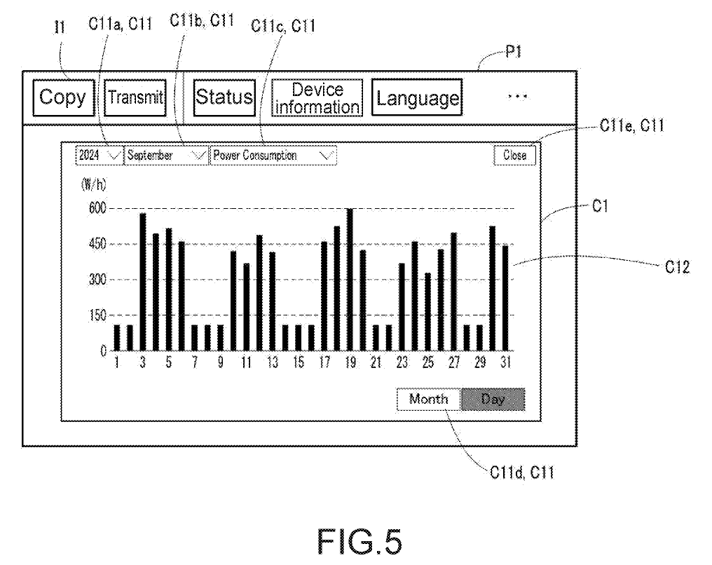

Hereinafter, display examples of the external content C1 on the operation screen P1 will be described with reference to FIGS. 5 to 10. Note that a first display example to a fifth display example to be described below are merely display examples of the external content C1 on the operation screen P1, and the display examples of the external content C1 are not limited thereto.

### First Display Example

In a first display example, when the operation device 3a detects an operation to change the size or position of the display region of the external content C1, the CPU 51 changes the size or position of the external content C1 in accordance with the operation. This makes it possible to enlarge or reduce the display region of the external content C1 on the operation screen P1 or to change the position of the display region, for example, with the display region of the external content C1 shown in FIG. 3 being used as a reference. Therefore, this has the advantage that the user can freely change the size or position of the external content C1 on the operation screen P1 and that it is easy to customize the operation screen P1 as desired by the user.

FIG. 5 is the first display example of the external content C1 on the operation screen P1. In the example shown in FIG. 5, the external content C1 is displayed on the substantially entire operation screen P1, except for the plurality of operation icons I1 arranged in the right-left direction in the upper part of the operation screen P1. The operation screen P1 shown in FIG. 5 is displayed on the display device 3b, for example, by the user performing an operation of enlarging the display region of the external content C1, such as an operation of touching the external content C1 consecutively a plurality of times (e.g., twice) or a pinch-out operation on the external content C1. When the enlarging operation is detected by the operation device 3a, the CPU 51 controls the native region and the display region of the external content C1 to enlarge the display region of the external content C1 on the operation screen P1. Note that, for example, when the user performs an operation of reducing the display region of the external content C1, such as a pinch-in operation on the external content C1, the CPU 51 controls the native region and the display region of the external content C1 to reduce the display region of the external content C1.

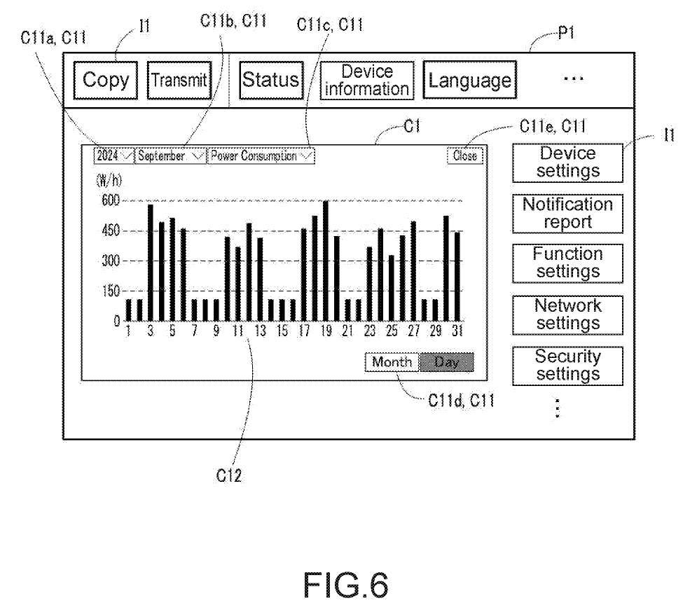

FIG. 6 shows another example of the first display example of the external content C1 on the operation screen P1. In the example shown in FIG. 6, the display position of the external content C1 on the operation screen P1 is changed to a left position from the right position as shown in FIG. 3. In addition, in the example shown in FIG. 6, along with the change in the display position of the external content C1, the display positions of the plurality of operation icons I1 located on the left side of the external content C1 in the example shown in FIG. 3 are changed to the right side of the external content C1. The operation screen P1 shown in FIG. 6 is displayed on the display device 3b, for example, by the user performing a position change operation of changing the position of the display region of the external content C1, such as a drag operation on the external content C1. When the operation device 3a detects the position change operation, the CPU 51 controls the native region and the display region of the external content C1 to change the display position of the external content C1 on the operation screen P1.

### Second Display Example

In a second display example, when the operation device 3a detects an operation on the operation icon C11 that is a content operation item, the CPU 51 causes the external system 8 to generate external content C1 changed in accordance with that operation, and displays the changed external content C1 on the display device 3b. Thus, the external content C1 is changed in real time, for example, in accordance with the user's operation on the external content C1, which has the advantage that the user easily operates the external content C1 in an intuitive manner.

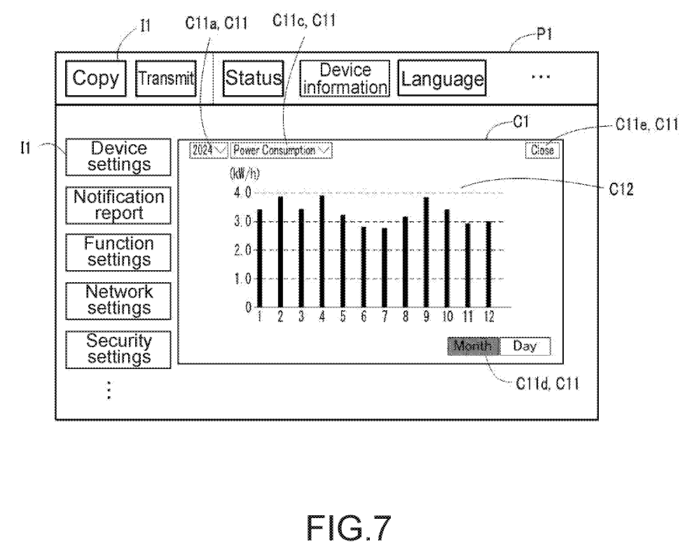

FIG. 7 shows the second display example of the external content C1 on the operation screen P1. In the example shown in FIG. 7, a graph image C12 indicating monthly power consumption of the image forming apparatus 10 is displayed in the external content C1 on the operation screen P1. The operation screen P1 shown in FIG. 7 is displayed on the display device 3b by the user performing a selecting operation of selecting "Month" on the fourth operation icon C11d of the external content C1 shown in FIG. 3. When the operation device 3a detects the selecting operation, the CPU 51 requests the external system 8 to generate external content C1 including a graph image C12 indicating monthly power consumption of the image forming apparatus 10 via the network 80. In response to the request, the external system 8 generates the changed external content C1 including a graph image C12 indicating monthly power consumption of the image forming apparatus 10, and transmits the changed external content C1 to the information processing apparatus (image forming apparatus 10) via the network 80. The CPU 51 then displays the changed external content C1, which has been received, on the operation screen P1.

### Third Display Example

In a third display example, the CPU 51 displays the operation icons I1 that are operation items at positions other than the display region of the external content C1 on the operation screen P1. Thus, the operation items displayed at the positions overlapping with the display region of the external content C1 are not hidden by the external content C1, which has the advantage that an operation of selecting the operation items can be performed in a similar manner to when the external content C1 is not displayed.

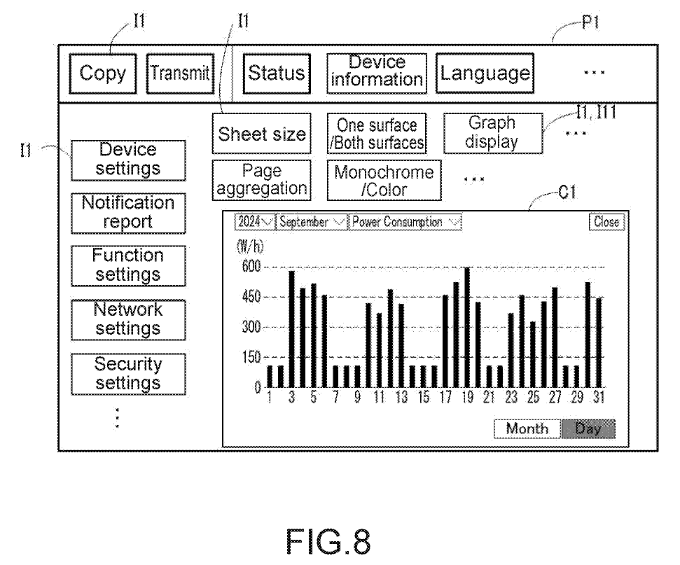

FIG. 8 shows the third display example of the external content C1 on the operation screen P1. Note that the illustration of reference symbols other than "C1" is omitted in the external content C1 shown in FIG. 8. In the example shown in FIG. 8, the operation icons I1 (operation items) of "sheet size", "page aggregation", "one surface/both surfaces", "monochrome/color", and "graph display" are displayed above the external content C1 so as to avoid overlapping with the display region of the external content C1. The operation screen P1 shown in FIG. 8 is displayed on the display device 3b, for example, by the user performing a selection operation of selecting the operation icon I11 of "graph display" on the operation screen P1 shown in FIG. 2. When the operation device 3a detects the selection operation, the CPU 51 generates a native region and a display region of external content C1 such that the display region of the plurality of operation icons I1 such as "sheet size" and the display region of the external content C1 do not overlap with each other. The CPU 51 then displays the generated native region and display region of the external content C1 on the display device 3b.

### Fourth Display Example

In a fourth display example, the CPU 51 acquires use information including an operation history on the operation screen P1. The CPU 51 then determines a display region of the operation icons I1 that are operation items and a display region of the external content C1 in accordance with the use information. Here, the operation history is, for example, a history of the operation icon I1 selected by the user on the operation screen P1. This provides, for example, the advantage that an operation item with a high frequency of use can be displayed on the operation screen P1 together with the external content C1 and an operation of selecting that operation item can be performed in a similar manner to when the external content C1 is not displayed.

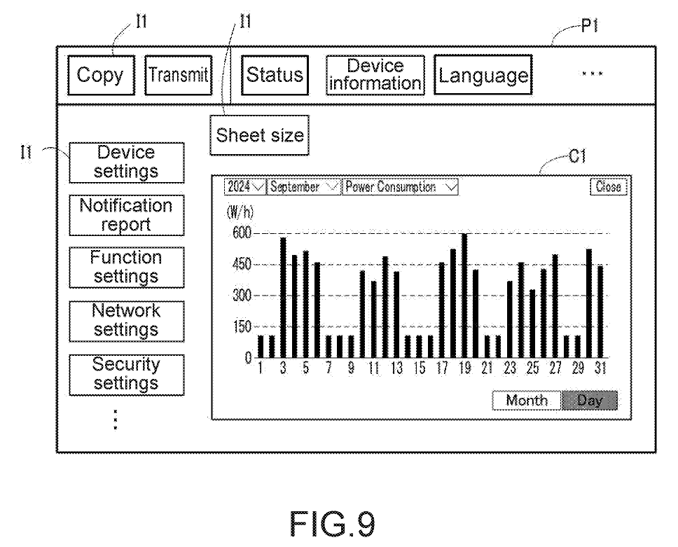

FIG. 9 shows the fourth display example showing the external content C1 on the operation screen P1. Note that the illustration of reference symbols other than "C1" is omitted in the external content C1 shown in FIG. 9. In the example shown in FIG. 9, the operation icon I1 (operation item) of "sheet size" with a high frequency of use is displayed, in accordance with the use information, above the external content C1 so as to avoid overlapping with the display region of the external content C1. The operation screen P1 shown in FIG. 9 is displayed on the display device 3b, for example, by the user performing a selection operation of selecting the operation icon I11 of "graph display" on the operation screen P1 shown in FIG. 2. First, the CPU 51 references the operation history to determine an operation icon I1 selected by predetermined times or more to be an operation icon I1 with a high frequency of use, for example. In the example shown in FIG. 9, the CPU 51 determines the operation icon I1 (operation item) of "sheet size" to be an operation icon I1 with a high frequency of use. Next, the CPU 51 generates a native region and a display region of external content C1 such that the display region of the operation icon I1, which has been determined to have a high frequency of use, and the display region of the external content C1 do not overlap with each other. The CPU 51 then displays the generated native region and display region of the external content C1 on the display device 3b.

### Fifth Display Example

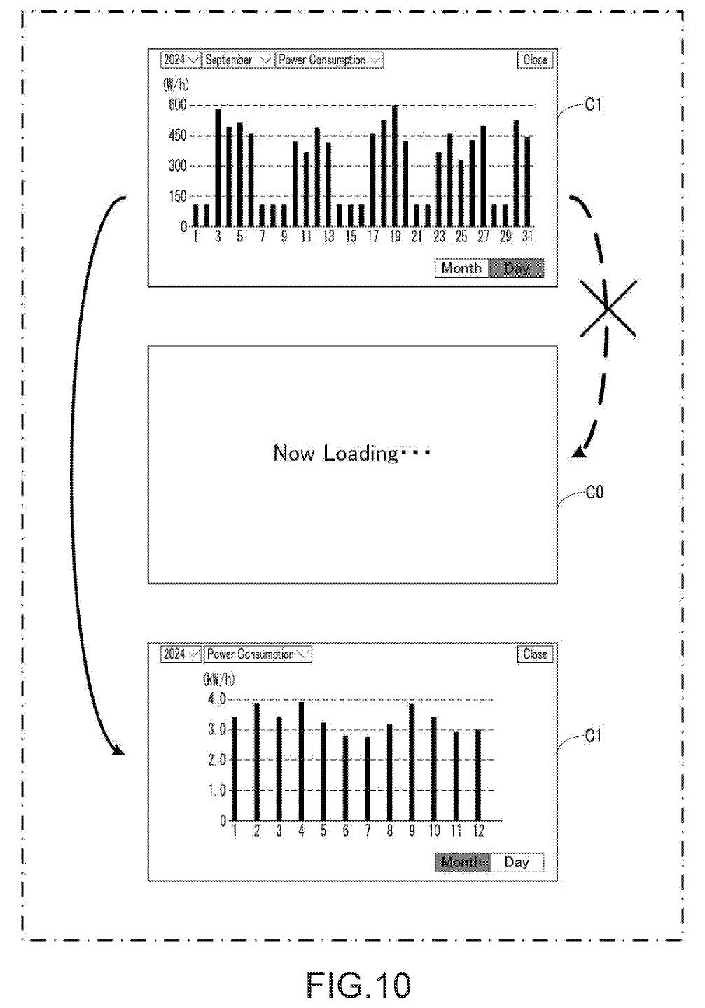

In a fifth display example, when the external content C1 includes a specific image C0 (see FIG. 10), the CPU 51 does not display the specific image C0 on the operation screen P1. Here, the specific image C0 includes, for example, an image such as "Now Loading …" indicating that the external content C1 is being updated. In addition, the specific image C0 includes, for example, an image such as "503 Service Unavailable" indicating that an abnormality occurs in the communication with the external system 8. This has the advantage that the user is not made aware of that the external content C1 displayed on the operation screen P1 is content displayed through communication with the external system 8, such as html content, and the user is less likely to feel uncomfortable.

FIG. 10 shows the fifth display example showing the external content C1 on the operation screen P1. Note that the illustration of reference symbols other than "C1" is omitted in the external content C1 shown in FIG. 10. The example shown in FIG. 10 displays the shift of display of the external content C1 when a user performs a selection operation of selecting "Month" on the fourth operation icon C11d of the external content C1 shown in FIG. 3. Specifically, as shown in the upper row of FIG. 10, before the selection operation is performed, a graph image C12 indicating daily power consumption of the image forming apparatus 10 is displayed in the external content C1. When the user performs the selection operation, as shown in the lower row of FIG. 10, a graph image C12 indicating monthly power consumption of the image forming apparatus 10 is displayed in the external content C1. At that time, in the fifth display example, the CPU 51 shifts display from the external content C1 shown in the upper row of FIG. 10 to the external content C1 show in the lower row of FIG. 10 without causing the display device 3b to display the specific image C0 shown in the middle row of FIG. 10.

### Modified Examples

In the embodiment described above, the external content C1 is the content generated by the external system 8 using the functions that the target apparatus (image forming apparatus 10) does not have, but it is not limited thereto. For example, the external content C1 may be content generated by the external system 8 using a function that the target apparatus has. Specifically, the target apparatus may have a specific function of generating an image including a bar graph using power consumption data, but may have poor processing capacity for implementing the specific function. In such a case, if the external system 8 having such a specific function and also having high processing capacity than that of the target apparatus is caused to implement the specific function and generate the image, that image can be promptly displayed on the display device 3b, as compared to the case where the target apparatus generates the image.

In addition, in the embodiment described above, the external content C1 may be, for example, content that can be simply displayed on a web browser and may include content that is not content generated on the basis of specific data.

### Notes of Disclosure

The outline of the disclosure extracted from the embodiment described above will be given below. Note that the configurations and processing functions described in the following notes can be discretionally selected and combined.

<Note 1>

An information processing method of controlling display of a display device in a target apparatus including the display device that displays an operation screen and an operation device that detects an operation on the operation screen, the information processing method including:

transmitting specific data stored in advance by the target apparatus to an external system, and receiving external content generated by the external system on the basis of the specific data; and

displaying the received external content on the display device in a state being superimposed on the operation screen,

the transmitting the specific data and receiving the external content and the displaying the received external content being executed by one or more processors.

<Note 2>

The information processing method according to Note 1, in which

the displaying the received external content includes changing, when the operation device detects an operation of changing a size or position of a display region of the external content, the size or position of the external content in accordance with the operation.

<Note 3>

The information processing method according to Note 1 or 2, in which

the external content includes a content operation item that receives an operation for the external content, and

the displaying the received external content includes causing, when the operation device detects an operation on the content operation item, the external system to generate the external content changed in accordance with the operation, and displaying the changed external content on the display device.

<Note 4>

The information processing method according to any one of Notes 1 to 3, in which

the operation screen includes an operation item that receives a corresponding specific operation, and

the displaying the received external content includes displaying the operation item at a position other than the display region of the external content on the operation screen.

<Note 5>

The information processing method according to any one of Notes 1 to 4, in which

the operation screen includes an operation item that receives a corresponding specific operation,

the information processing method further includes acquiring use information including an operation history on the operation screen, and

the displaying the received external content includes determining a display region of the operation item and a display region of the external content in accordance with the use information.

<Note 6>

The information processing method according to any one of Notes 1 to 5, in which

the displaying the received external content includes preventing, when the external content includes a specific image indicating that the external content is being updated or that an abnormality has occurred in communication with the external system, the specific image from being displayed on the operation screen.

<Note 7>

The information processing method according to any one of Notes 1 to 6, in which

the external content is generated by the external system, using a function that the target apparatus does not have.

<Note 8>

An information processing apparatus, including:

a display device that displays an operation screen;

an operation device that detects an operation on the operation screen; and

one or more processors that implement the information processing method according to any one of Notes 1 to 7.

<Note 9>

An image forming apparatus, including:

a printing device that forms an image on a sheet;

a display device that is capable of displaying the image;

an operation device that detects an operation on the operation screen; and

one or more processors that cause the display device to display an operation screen of a target apparatus including the printing device, and implement the information processing method according to any one of Notes 1 to 7.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing method of controlling display of a display device in a target apparatus including the display device that displays an operation screen and an operation device that detects an operation on the operation screen, the information processing method comprising:
transmitting specific data stored in advance by the target apparatus to an external system, and receiving external content generated by the external system on a basis of the specific data; and
displaying the received external content on the display device in a state being superimposed on the operation screen,
the transmitting the specific data and receiving the external content and the displaying the received external content being executed by one or more processors.

2. The information processing method according to claim 1, wherein
the displaying the received external content includes changing, when the operation device detects an operation of changing a size or position of a display region of the external content, the size or position of the external content in accordance with the operation.

3. The information processing method according to claim 1, wherein
the external content includes a content operation item that receives an operation for the external content, and
the displaying the received external content includes causing, when the operation device detects an operation on the content operation item, the external system to generate the external content changed in accordance with the operation, and displaying the changed external content on the display device.

4. The information processing method according to claim 1, wherein
the operation screen includes an operation item that receives a corresponding specific operation, and
the displaying the received external content includes displaying the operation item at a position other than the display region of the external content on the operation screen.

5. The information processing method according to claim 1, wherein
the operation screen includes an operation item that receives a corresponding specific operation,
the information processing method further comprises acquiring use information including an operation history on the operation screen, and
the displaying the received external content includes determining a display region of the operation item and a display region of the external content in accordance with the use information.

6. The information processing method according to claim 1, wherein
the displaying the received external content includes preventing, when the external content includes a specific image indicating that the external content is being updated or that an abnormality has occurred in communication with the external system, the specific image from being displayed on the operation screen.

7. The information processing method according to claim 1, wherein
the external content is generated by the external system, using a function that the target apparatus does not have.

8. An information processing apparatus, comprising:
a display device that displays an operation screen;
an operation device that detects an operation on the operation screen; and
one or more processors that implement the information processing method according to claim 1.

9. An image forming apparatus, comprising:
a printing device that forms an image on a sheet;
a display device that is capable of displaying the image;
an operation device that detects an operation on the operation screen; and
one or more processors that cause the display device to display an operation screen of a target apparatus including the printing device, and implement the information processing method according to claim 1.
